(19) United States
(12) Patent Application Publication
(10) Pub. No.: US 2021/0065234 A1
(43) Pub. Date: Mar. 4, 2021

(54) IDENTIFICATION OF VISIT LOCATION AND CONNECTION WITH TRACKED EVENTS

(71) Applicant: ADARA, Inc., Palo Alto, CA (US)

(72) Inventors: Piyush Shrivastava, Fremont, CA (US); Christopher Anthony Bruni, Palo Alto, CA (US)

(21) Appl. No.: 16/556,176

(22) Filed: Aug. 29, 2019

(51) Int. Cl. G06Q 30/02; G06F 16/9537; G06F 16/29

(52) U.S. Cl. CPC G06Q 30/0246; G06F 16/29; G06F 16/9537

(57) ABSTRACT

Techniques are described for determining visit locations on a per-user basis. In a disclosed method, user-location data, from a plurality of distinct data sources, is received over one or more network systems. The user-location data includes a plurality of user-location records and indicate visits made by the plurality of users to the plurality of locations. Each user-location record includes at least: user-identification data that uniquely identifies a user; location data that identifies a location visited by the user identified in the user-location record; and time data that indicates when the user identified in the user-location record visited the location identified ion the user-location record. Based on the plurality of user-location records, for each user of the plurality of users, whether any location visited by the user qualifies as a home-location for the user is determined. Locations visited by each user that do not quality as the home-location for the user are away-locations of the user.

### FIELD OF THE INVENTION

The general technical field of the present disclosure is software-programmed computers in network systems. The technical field of the disclosure relates more specifically to an automated system for detecting when users visit locations outside their home area.

### BACKGROUND

Companies monitor the online behavior of users for a variety of reasons. Information about online behavior may be used, for example, to select users to target with specific marketing campaigns. For example, a particular user may visit a tourist site about Hawaii. If this online behavior is captured, and a marketing service becomes informed of the user's online behavior, then the marketing campaign ‘Visit Hawaii’ may be targeted to the user. Based on impressions of or exposure to marketing campaigns, the user may decide to visit Hawaii.

Unfortunately, online behavior only reflects half of the story. Specifically, a user's exposure to a marketing campaign may prompt real-world “travel behavior”, such as actually visiting Hawaii, that is not necessarily reflected in the user's online behavior. As another example, a user exposed to an advertisement for a brick-and-mortar store may actually visit the store, rather than visit the store's website. Thus, to judge the efficacy of a marketing campaign for a store that is physically located at a particular location, it is important to know how many users exposed to the marketing campaign actually physically travel to that particular location.

Various techniques have been developed to collect information about the real-world locations of users. For example, telecom companies may gather location information from mobile phone users based on where a user's mobile phone calls originate. Similarly, applications installed on mobile devices may also attempt to gather location information from the mobile devices on which they are running.

Unfortunately, it has proven difficult to use location information obtained from a single source (e.g. a telecom company or a mobile application) to determine the effectiveness of marketing campaigns. The problems include, but are not limited to:

The data collected from these sources is often inaccurate and/or stale.

The data collected from application location/telecoms may not be privacy compliant and may not require explicit user consent.

The data collected from these sources is sparse and therefore does not give an accurate depiction of actual movement which leads to inaccurate interpretation of visitation patterns.

Most of the existing approaches are not able to connect the visitation with a particular marketing campaign, and therefore the party that is running the marketing campaign has to infer the influence of their marketing campaign from overall visitation behavior. That is, information from a telecommunication company may indicate how many users attended a particular festival, but says nothing about whether those that attended did so due to exposure to any particular marketing campaign.

Existing approaches do not correlate the visitor behavior with their transactional behavior.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a multi-source transactional-based management system (MSTMS), in an embodiment,

FIG. 2 is a flowchart that depicts a process for determining the efficacy of marketing campaigns, according to an embodiment,

FIG. 3 is a block diagram of a basic software system, in one or more embodiments,

FIGS. 4A-4D are block diagrams of the correlation operations performed at the various phases of a marketing campaign efficacy analysis operation, in an embodiment,

FIGS. 5A-5I are example displays of aggregated information based on user behavior patterns produced by a MSTMS, in an embodiment, and

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Data set collections from disparate data sources (“originating sources”) are processed to identify patterns of user behavior and movement. Heuristics based on user behavior and movement and patterns are developed and displayed for comparison and analysis. The analysis may be useful, for example, in promoting effective marketing campaign planning. However, use of the techniques described herein is not limited to marketing campaign evaluations.

Techniques are provided for using travel data to determine the home-locations for users. Based on the home-locations and the travel data, the “away-locations” of each user may be determined. Techniques are further provided for mapping the away-locations of users to the geo-location of entities (e.g. stores, events, etc.) to determine a set of “visited-entities” for each user.

A user's set of visited-entities may then be correlated with the user's online behavior. Such correlations may indicate, for example, the effectiveness of marketing campaigns. For example, by correlating the visited-entities of users with the online behavior of users, it may be determined how many people that were exposed to a particular marketing campaign for Hawaii actually visited Hawaii, and the average amount they spent while in Hawaii. This can be compared, for example, against the average amount spent by others who visited Hawaii during that same time period but were not exposed to the particular marketing campaign.

### Originating Sources

An originating source is any source from which data is obtained. Originating sources may vary in type. Non-limiting examples of data source types are social media, media, and search websites, but exclude telecom or application programs with sensitive user data. An “originating source system” is a computer system used and/or controlled by an originating source.

Nonlimiting examples of tracking data include cookie identification (ID) data, or data identifying one or more online locations visited by a user.

### User-Location Records

One type of data that the system described herein may collect from originating sources includes user-location data. The user-location data may include user location records that uniquely identify users and locations visited by the users. According to one embodiment, within the user-location data, the data used to uniquely identify users does not include any sensitive user-specific identifying information, such as telephone numbers and physical addresses.

According to an embodiment, to determine the visited-entities of a user, a system receives, over one or more network systems, user-location data from a plurality of distinct sources. The user-location data may be in the form of user-location records. Alternatively, the user-location data may be in other forms, from which user-location records may be derived. The user-location records indicate visits made by users to physical locations.

According to one embodiment, each user-location record includes at least:
user-identification data that uniquely identifies a user;
location data that identifies a location visited by the user identified in the user-location record; and
time information that indicates when the user identified in the user-location record visited the location identified in the user-location record.

Based on the user-location records, the system determines, for each user, whether any location visited by the user qualifies as a “home-location” for the user. Locations visited by each user that do not qualify as the home-location for the user are referred to herein as “away-locations” for the user.

Nonlimiting examples of user identifying data may be electronic address (email) data, a digital address associated with a user and entity account data, and data associated with an online user account.

Location data is data identifying a physical location visited by a user. The location data may take many forms, such as GPS coordinates or a street address.

Time data is data identifying time associated with user location, movement or activity. In an embodiment, device identification (ID) data is data uniquely identifying a user electronic device, such as a personal computer or a mobile phone.

### Home-Locations and Away-Locations

Connections between users and travel destinations may be denoted by one or more criteria and inferred based on user location records. In an embodiment, a user destination location may qualify as user home-location or user away-location. Home-location and away-location may each be inferred based on corresponding user location records. In a non-limiting example, heuristics based on compiled user-location records may be determined from a user traveled location qualifying as user home-location. In an embodiment, a location visited by a visitor but not qualified as home-location may qualify as away-location. A user may have more than one visit location, and/or more than one home-location. However, a user's home-location(s) and away-location(s) are mutually exclusive.

In some situations, no location may qualify as a home-location for a user. In an embodiment, a nonlimiting qualifier may be away-locations are any locations other than home-locations visited by the users. Other criteria may qualify one or both home and away-locations.

### Entity-Specific Geo-Configuration Data

Entity-specific geo-configuration data characterizes a corresponding destination entity. “Entity-specific geo-configuration data” is data corresponding to, associated with, or relating to an entity (or “destination entity” or “destination”). “Destination entity” may be one or more locations, regions, businesses, events or a group of entities. Entity-specific geo-configuration data may be determinative of one or more (destination) entities. One or more geo-locations may be associated with a single destination entity.

### Visited-Entities

After determining the away-locations for each user, the system compares the away-locations against entity-specific geo-configuration data that indicates, for each entity of a plurality of entities, one or more geographic locations associated with the entity. An entity may be, for example, a chain of brick-and-mortar stores. The geographic locations associated with the such a store chain would be the physical locations of branches of the store chain. From the away-locations of each user, the system determines one or more visited-entities for the user based on (a) the entity-specific geo-configuration data, and (b) the user-location records of the user.

### Exposure Impact

Once the visited-entities of each user are known, the system may use this information to determine the impact of exposure to particular content. For example, for a given store, the system may determine a subset of users that (a) were exposed to particular content (e.g. from a marketing campaign), and (b) visited the store. After determining that subset of users (the “exposed visitors”), the system may generate a display that includes aggregate information about the exposed visitors, such as how much they spent at the store. The aggregate information about exposed visitors may be compared with similar aggregate information for users that visited that store that had not been exposed to the marketing campaign (“unexposed visitors”).

To improve the accuracy of estimating the impact of marketing plans, accuracy of observed events is improved by connecting temporal information associated with user travel locations and user destination market definitions. Correlation between (a) users (or visitors) to a destination, and (b) transactional data, makes it possible to infer economic activity impact of visitors at a given destination.

Unlike existing systems and techniques, sensitive information, such as physical home or work addresses, phone numbers, and names, remain unknown and excluded from user identification, therefore alleviating privacy law violation concerns.

### System Overview

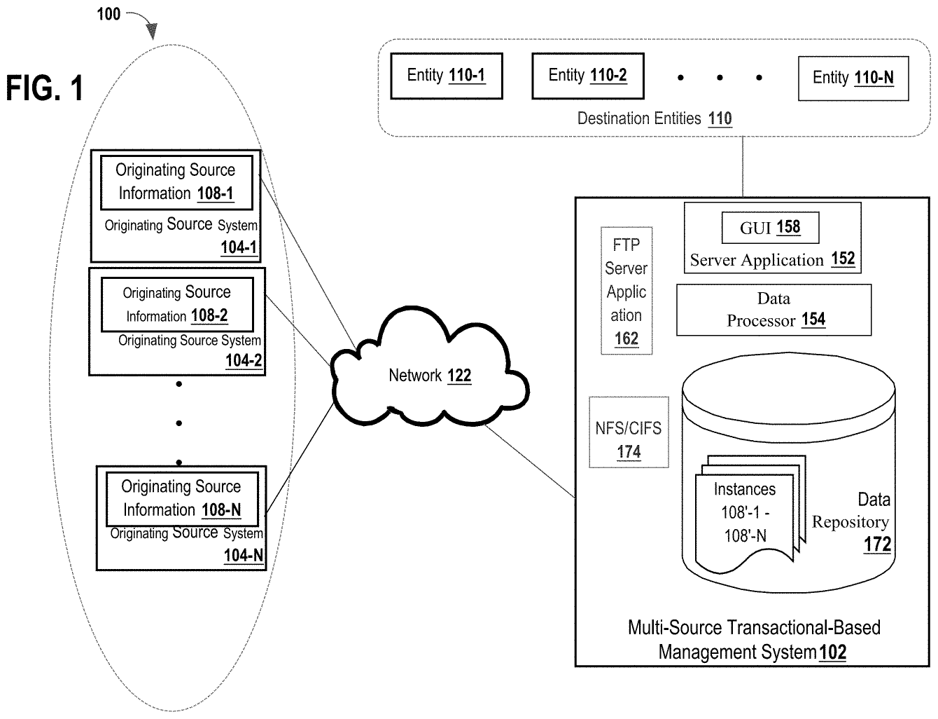

According to one embodiment, a multi-source transactional-based management system (MSTMS) is used to gather travel data from multiple sources, and then correlate that data with online behavior data and transaction data. FIG. 1 is a block diagram illustrating an embodiment of such an MSTMS 102. MSTMS 102 stores a collection of data records of data sets originating from disparate sources 100. Each data set is associated with a distinct source, which itself may represent a group of sources, in an embodiment. In an embodiment, MSTMS 102 is configured or programmed to correlate user travel behavior with user transactional behavior.

In a nonlimiting example, the MSTMS 102 connects observed events across disparate data sources to build a temporal view of user observed locations and to infer user home-locations; identify user travel times; connect user travel locations with destination market definitions; connect traveler users with event exposures across different channels and vendors to assess event influence on visit destinations; and connect visitors destinations with transaction data to infer visitor economic activity impact at a given destination.

In an embodiment, MSTMS 102 comprises one or computer systems coupled to one or more originating source systems 104-1, 104-N. Any number of originating source systems 104-1, 104-N may be deployed in a distributed computing system of this type, as indicated by the designation “N” in 104-N. MSTMS 102 and originating source systems 104-1, 104-N may be in different locations such as different states, countries or other geographical or political units.

In one embodiment, MSTMS 102 hosts, executes or comprises a server application 152, FTP server application 162 and data repository 172. In an embodiment, server application 152 implements an application in communication with compatible instances 108′ of originating source information 108 that are hosted at the originating source systems 104-1, 104-N. The server application 152 may include presentation layer or graphical user interface (GUI) 158. The GUI 158 may be programmed to generate HTML documents, vector data, or other data that can be displayed or rendered at the originating source systems 104-1, 104-N to cause visually displaying data, images, text and the like representing prompts, GUI widgets, output data, reports and the like as part of the business application.

Network 122 broadly represents a digital data telecommunications network comprising any combination of a local area network (LAN), a wireless LAN (WLAN), a wide area network (WAN), a wireless WAN (WWAN), a metropolitan area network (MAN), an ad hoc network, an intranet, an extranet, a virtual private network (VPN), a portion of the Internet, the Internet, a portion of a public switched telephone network (PSTN), or a cellular network.

In an embodiment, network 122 may include one or more networks. MSTMS 102 may be a distributed computing or networking system including one or more computing or storage devices remotely distributed relative to one another. In an embodiment, MSTMS 102 or any components of MSTMS 102 may be implemented in hardware, software or in one or more virtual machines.

In an embodiment, systems 104 establish a connection with MSTMS 102 using one or more protocols to transmit one or more data sets for processing by MSTMS 102. One technique to transmit a data set is for originating source systems 104 to upload a file containing the data set to MSTMS 102. For example, originating source system 104-1 may use originating source application 108-1 to transmit the file over FTP/SFTP protocol to FTP server application 162. Upon receipt of the file, FTP server application 162 may store the data set file for MSTMS 102 to process the data set(s) of the file and store them in data repository 172.

In another embodiment, MSTMS 102 may expose one or more of its directories coupled to data repository 172 through a network file system such as NFS/CIFS 174. Each of the originating source systems 104 may mount the network directory using a respective originating source information 108 and transfer a data set file into the mounted directory. The transfer would trigger transmission of a copy of the data set file over network 122 to the mounted directory of MSTMS 102. MSTMS 102 processes data set(s) of the file and stores the data set(s) in data repository 172. Additionally, data repository 172 may store heuristics files.

In yet another embodiment, one or more of the originating source information 108 is a web browser which is used by a user of a respective originating source system 104 to perform user actions. User actions, or events, may be browsing websites, clicking on interesting content or expressive icons.

In an embodiment, originating source systems 108 transmit data sets in files using HTTP(s) (Hyper-Text Transfer Protocol) to server application 152. Upon the receipt, server application 152 may process and store data set(s) of the file in data repository 172.

In a nonlimiting example, originating source systems 104-1, 104-2, and 104-N each include respective originating source information, that may be different from one another. For example, originating source systems 104-1, 104-2, 104-N are sources of travel data 108-1, conversion information 108-2 (e.g. information about transactions/purchases made by users), and impression information 108-N (e.g. information about online behavior and/or exposures), respectively. Each of the originating source systems 104 facilitates transmission of corresponding originating source information 108, arranged in a data set, to MSTMS 102 through the network 122.

The format and content of the originating source information may vary from originating source to originating source. For example, originating source system 104-1 may be a computing device with a web application that generates tracking data of user-visited websites. Originating source system 104-2 may be a conversion computing device with a conversion application that generates conversion data identifying users performing acts that qualify as a conversion. Unlike “impression”, where a user may click on an online advertisement, “conversion” is the user purchasing an advertised item at a previously user clicked online site advertising the item. Originating source system 104-N may be a web computing device with a search engine, a social media, or media site information, such as Google, Facebook, or YouTube, respectively, that generates impression data.

“Impression” data is data that represents user clicks on a displayed marketing campaign of a website, such as, a Facebook page or a YouTube movie clip page. Yet another originating source system may be a transactional system with a transactional application that generates transactional data. Transactional data may be payment data identifying user online financial transactions, an airline flight reservation purchase, for example.

In an embodiment, MSTMS 102 includes data processor 154, which generally represents one or more processors. Data processor 154 facilitates processing of data sets from originating source systems 100. In an embodiment, data sets from originating source systems 100 are received in user location records. In an embodiment, data sets from originating source systems 100 are arranged into user location records by data processor 154. Data processor 152 stores received user location records in data repository 172.

Data repository 172 may be maintained as any type of data store such as a file repository, an SQL (Structured Query Language) database management system, a non-SQL database management system or any other database management system.

In an embodiment, one or more of originating source systems 104-N of originating source systems 100 may be locally or remotely located relative to one another.

Data sets of originating source information of originating source systems 104 may be of different format types. For example, visitor, conversion, and transactional data sets may each emanate from a different source code, Hypertext Markup Language format or Cascading Style Sheets (CSS), each generating different data format structures. In an embodiment, data sets from originating source systems 100 are arranged in user location record sets. After receiving a collection of data sets from originating source systems 100, MSTMS 102 identifies user identifying data, associated with a common user, across all data sets (from all data sources) and saves the identifying data in data repository 172.

As earlier discussed, MSTMS 102 correlates the data obtained from the various originating source systems 100. In the example of using a cookie ID as user identifier, for every cookie ID, a time series (or time period) of all user visited locations are identified.

In an embodiment, a unique user identification identifies a specific user across all data sources based on the data received from originating source systems 100. The user identification may be one or more numbers, one or more characters, or a combination thereof, or any other form of an identifying indicator that can be a part of the user location data. In an embodiment, a specific user is identified across all data sources based on a matching user identifier represented by user identifying data across all data sets. In an embodiment, a match between a user identifier, identifying a user, and a device identifier, identifying a user electronic device, is inferred because, presumably, the user and the user device are at a common location.

### Process Overview

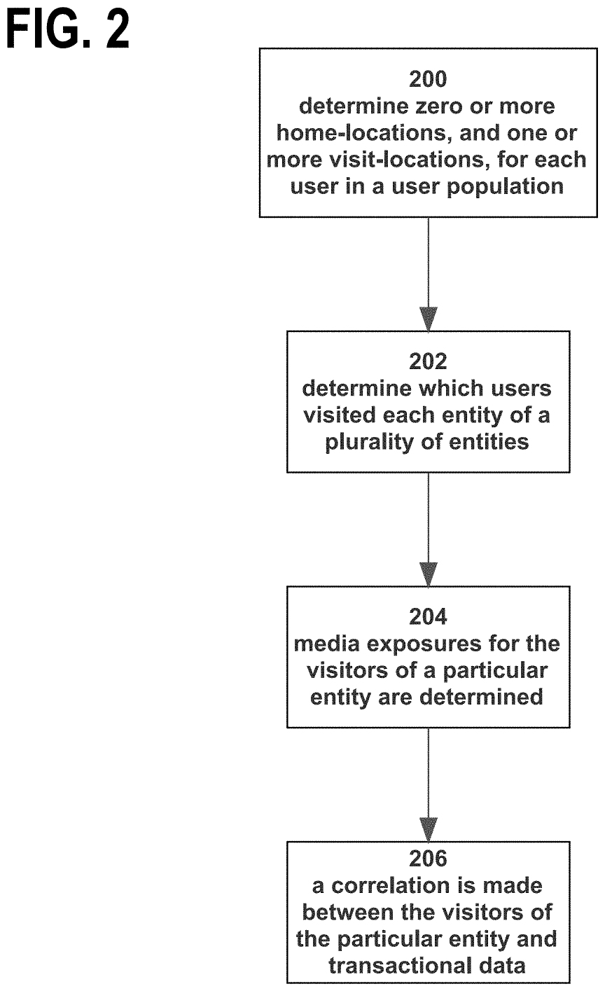

According to one embodiment, the process of determining the impact of exposure to particular content is performed in four distinct phases, as illustrated in FIG. 2. During the first phase (step 200), the system determines zero or more home-locations, and one or more away-locations, for each user in a user population.

During the second phase (step 202), the system determines which users visited each entity of a plurality of entities. The entities may be events (e.g. festivals), buildings (e.g. stores), or anything that is associated with one or more real-world geographic locations.

During the third phase (step 204), media exposures (Website visits, social media, digital media, TV etc.) for the visitors of a particular entity are determined.

During the fourth phase (step 206), a correlation is made between the visitors of the particular entity and transactional data, such as purchases relating to Air, Hotel, Car, Attraction, Rail etc.

Each of these phases shall be described in detail hereafter.

### Phase 1: Determining Home-Locations and Away-Locations

As previously discussed, MSTMS 102 receives data sets from originating source systems 100. Several of the originating source systems may provide travel data that indicates the physical locations of users. In an embodiment, from that travel data, MSTMS 102 determines user home-locations and user away-locations.

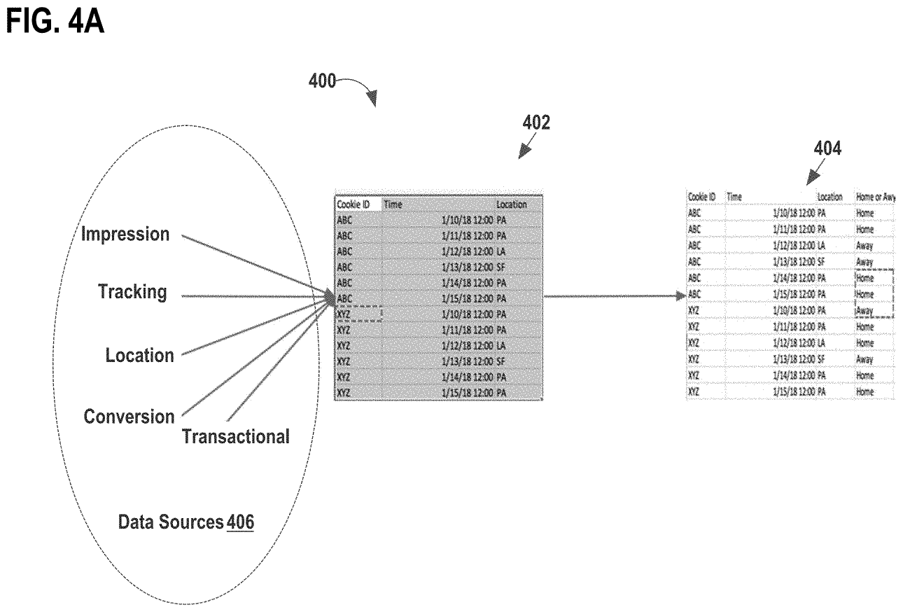

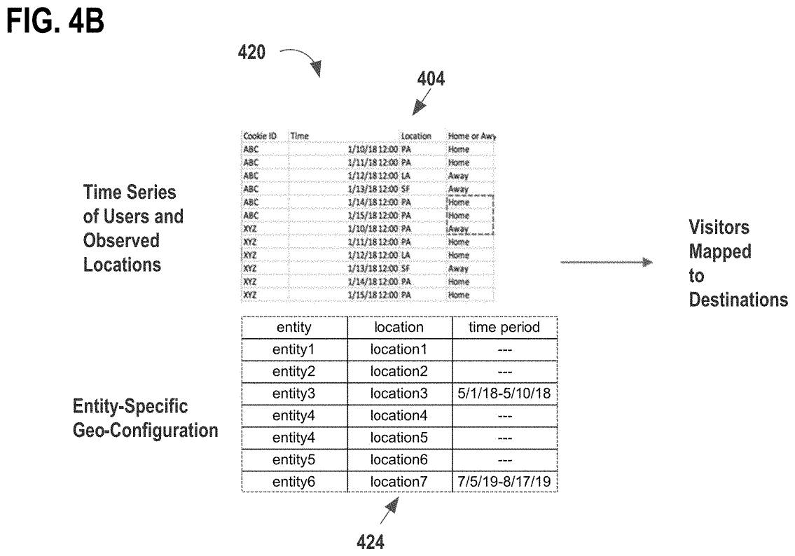

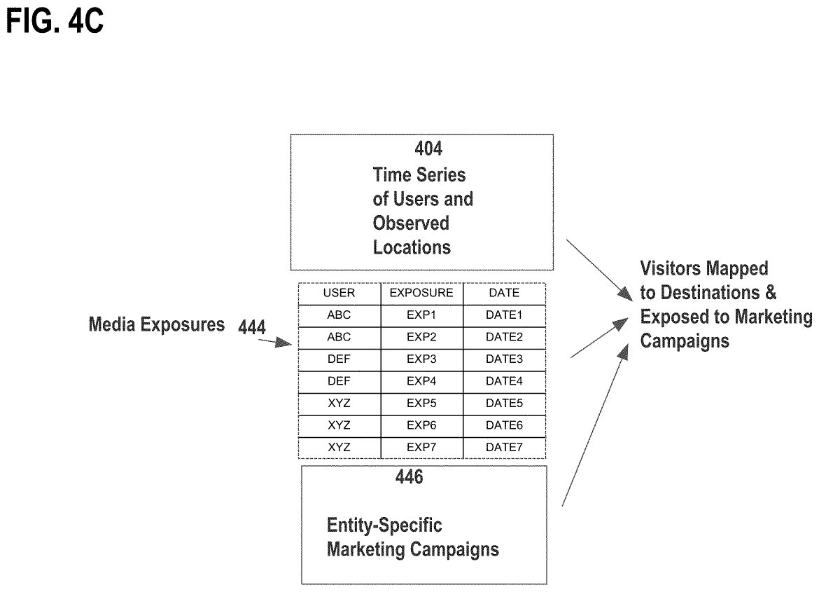

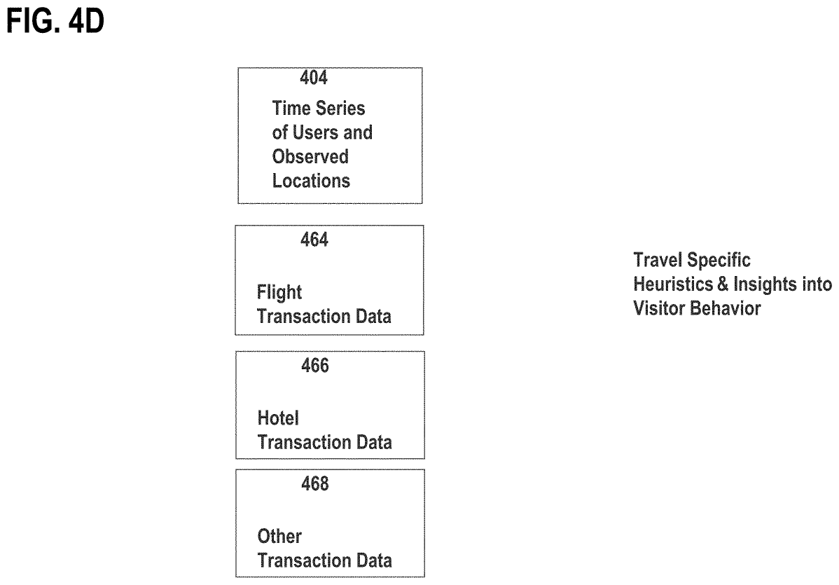

Referring now to FIG. 4A, MSTMS 102 receives data from disparate data sources 406 and stores associated user data records in data repository 172. In an embodiment, data sources 406 may be originating source systems 100. In the example of FIG. 4A, data sources 406 provide many various types of data, including but not limited to media impression data, impression tracking data, travel data, conversion data, and transactional data.

A user common to one or more of the data sources 406, is identified across data sets from all data sources, with a corresponding user identifier. The user identifier may be a cookie ID, for example. In the embodiment illustrated in FIG. 4A, MSTMS 102 arranges the data sets collected from data sources 406 into a table 402, where each row of table 402 represents a user-location record. The user-location records in table 402 may be derived from millions of cookies used to track large numbers of users over an extended time period, such as six months.

As illustrated in FIG. 4A, for each of two users (represented by the cookie IDs ‘ABC’ and ‘XYZ’), the user-location records within table 402 identify the locations of the users at specific times. Taking into account all of the location-records for a given user, MSTMS 102 uses heuristics to determine whether any of the locations visited by the user qualify as home-locations. A location may qualify as a home-location, for example, if the user has visited the location more frequently and for longer durations than other locations. In the illustrated example, it has been determined that the home-location for user ABC is PA, because user ABC is in PA more frequently than other locations.

User locations that do not qualify as home-locations qualify as user away-locations. As illustrate in FIG. 4A, table 404 is table 202 with an additional column that indicates, for each user-location record, whether the record corresponds to a home-location or a away-location. In the illustrated embodiment, a home-location is indicated by the value “home”, and a away-location is indicated by the value “away”.

In an embodiment, MSTMS 102 infers user home-locations and user non-home-locations by applying heuristics to user location data representing user visited locations, at scale, to determine user home-locations and user non-home-locations. In an embodiment, MSTMS 102 determines user home-locations and user non-home-locations based on one or more criteria. For example, MSTMS 102 may determine that a visited location qualifies as a home-location of a user if:
the location being the most-frequently visited location of the user, within the last six-month period; and
the user visited the location at least a threshold number of times during that six-month period.

In an embodiment, MSTMS 102 qualifies a user home-location based on frequency of user visits to a particular location, for example, a majority of the time. In an embodiment, user home-location may be determined based on a minimum frequency threshold of user visits to a particular location based on the user visit time duration or a minimum time duration threshold while visiting the location. For example, a particular location visited more than 50% of the time by a specific user may qualify the particular location as the user home-location. Continuing with the example, if the user spends more than 50% of the user time in Hawaii, the user home-location is presumed to be Hawaii. If the user travels frequently and cannot meet the 50% minimum frequency threshold with any traveled location, the user has no home location. One or more other criteria may qualify a user home-location.

In an embodiment, user home-locations are dynamic and evolving. For example, a user living in the Bay Area more than 50% of the time and subsequently relocating to Hawaii and spending more than 50% of the time in Hawaii and 20% of the time in the Bay Area has an initial qualifying home-location in the Bay Area, and a subsequent qualifying home-location in Hawaii.

According to one embodiment, based on the user-location records of each user, a time series of observed locations is generated for each user. Returning again to FIG. 4A, using cookie ID ‘ABC’, MSTMS 102 determines that a user with an associated cookie ID “ABC” is at home, Pennsylvania, on the first, tenth, fourteenth, and fifteenth of January, 2018, and away at Los Angeles and San Francisco on the twelfth and thirteenth of January, 2018, respectively. The user identified by cookie ID “XYZ” is inferred to be at home on the eleventh, twelfth, fourteenth, and fifteenth of January, 2018 and away at Pennsylvania, on Jan. 10, 2018, and San Francisco on Jan. 13, 2018.

In an embodiment, MSTMS 102 may infer user movement and location based on time stamp differentials. For example, user movement may be presumed unchanged at a specific location if the user is identified at the specific location at two subsequent and close specific times like five minutes apart. Specific times, identified by time stamps, may also determine a time period during which a user visited a particular location.

As mentioned above, the home-location(s) of a user may be identified based on visit frequency and visit time duration. For example, if a user has been observed 50 percent of the time at a given location, then the location is presumed to be the user home-location. In an embodiment, a home-location is dynamically, for example at regular time intervals, recalculated as data sets are refreshed or updated. For example, home-locations may be qualified on a daily, weekly, or monthly basis. In some cases, users may have multiple home-locations. In other cases, users may not have any home-location because no location meets the relevant criteria.

### Correlating Identifiers

In some cases, MSTMS 102 may determine that (a) a unique identifier encountered in data from one data source, and (b) a different unique identifier encountered in data from another data source, correspond to the same user. For example, from one source, the user identifying data may be a device ID (e.g. device ABC), identifying one or more user devices associated with a user. From a second data source, the user identifying data may be an email address (e.g. fred@email.com). From a third data source, the user identifying data for the same user may be a cookie ID X.

In some cases, the information provided to MSTMS 102 may specify correlations between unique identifiers. For example, data received from one source may specify both a cookie ID and a device ID. Data received from another source may specify both a device ID and an email address. Based on this information, MSTMS 102 may determine that the same user corresponds to “device ABC”, to email address “fred@email.com”, and to “cookie ID X”. Based on this correlation between identifiers, the data from the first source that is associated with the device ID ABC, the data from the second source that is associated with fred@email.com, and data from the third data source that is associated with cookie ID X, are treated as data about the same user.

As another example, in response to receiving user credentials provided by a user to access Airline 1 application, MSTMS 102 links Airline 1 user account information with the corresponding user device ID ABC to track user activity. User browsing activity may be tracked with cookie IDs while the user continues to employ the user device identified by the user device ID. MSTMS 102 may track user activity and actions from thereon using cookie IDs (without requiring knowledge of user credentials).

In an embodiment, a user may be associated with more than one user device. For example, a user may employ multiple electronic devices, such as one or more tablets and one or more mobile phones, uniquely identified, individually or in sets, by a device ID of one or more user location records. In an embodiment, one or more user location records are linked to a single user based on a common user identifying data.

### Phase 2: Determining Entities Visited

During phase 1, the visits of each user are divided into visits to home-locations and visits to away-locations. In phase 2, the visits to away-locations are mapped to entity-specific geo-configuration data to determine a set of “visited entities” for each user. The visited entities of each user are those entities (places, stores, events) that were physically visited by the user during the relevant time period.

Referring to FIG. 4B, it illustrates how user away locations are combined with entity-specific geo-configuration data, according to an embodiment. Entity-specific geo-configuration data 424 is data that identifies the location(s) associated with each entity. In the case that the entity is a place, such as Hawaii, the geo-configuration data for the entity may indicate the geographic boundaries of the place. In the case the entity is a physical store, the geo-configuration data for the store may indicate the geographic boundaries of the physical store. In the case where the entity is an event (e.g. a festival or concert), the entity-specific geo-configuration data for the event may indicate the geographic boundaries of the place were the event occurred, and may further include a specific time period during which the event occurred.

As mentioned above, entities may be places. For example, the US may be an entity, California may be an entity, and Los Angeles may be an entity. As is made clear by these examples, the geo-boundaries of entities may overlap. Thus, a visit to Los Angeles also qualifies as a visit to California, which also qualifies as a visit to the US.

As illustrated in FIG. 4B, some entities (e.g. places and stores) may not have any time period information, while other entities (e.g. events) do have time period information. Further, some entities, such as entity 4 in FIG. 4B, may have multiple locations. Entity 4 may be, for example, a chain of stores, where each location of entity 4 corresponds to a different store location.

As mentioned above, during phase 2, away-location visits of each user are mapped to entity-specific geo-configuration data 424 to determine which entities were visited by each user. In an embodiment, a visit to an entity is defined as a visit to an away-location that falls within the boundaries specified in the geo-configuration data of the entity. Because the geo-boundaries of entities may overlap, a single visit can map to multiple entities. For example, a visit to San Francisco is considered a visit to two other entities, California and the US.

At the end of phase 2, a set of visited-entities has been established for each user.

### Phase 3: Correlating Media Exposures

After having determined the set of visited-entities for each user in phase 2, it is possible to determine the set of users that visited each entity. The set of users that visited a given entity are referred to herein as the entity's “confirmed visitors”. During phase 3, information about each entity's confirmed visitors is correlated with other information that has been gathered about the confirmed visitors. That information may include, among other things, exposure data. Exposure data may be based on information about website visits, such as visits to Facebook and Instagram, and YouTube.

In an embodiment, an exposure may carry a weight. Exposures may be given equal weight (full attribution) or different weights (partial attribution). Data sets or user location records may indicate the nature of exposure (e.g. whether the exposure was “searching” or “clicking”).

Referring to FIG. 4C, it shows that, after an entity's confirmed users have been identified (404), those confirmed users can be correlated with user-specific media exposures 444. Once the media exposures of a confirmed visitor of an entity are known, those media exposures can be compared against the marketing campaigns 446 of the entity in question to determine whether the confirmed visitor was exposed to any content from any of the entity's marketing campaigns. For example, assume that the Hawaiian Board of Tourism has commissioned various marketing campaigns to encourage people to visit Hawaii. Assume further that, during phase 2, the system determined that user X is a confirmed visitor to Hawaii. The media exposure data for user X indicates whether, prior to visiting Hawaii, user X was exposed to any content associated with any of the various marketing campaigns for Hawaii. If so, then user X is an exposed-confirmed-visitor to Hawaii. Otherwise, user X is an unexposed-confirmed-visitor to Hawaii.

In this manner, based on media exposures and the information about the marketing campaigns, the confirmed visitors for an entity are divided into exposed-confirmed-visitors and unexposed-confirmed-visitors. Exposed-confirmed-visitors are those confirmed visitors that were exposed to content of one of the entity's marketing plans. Unexposed-confirmed-visitors are those confirmed visitors that were not exposed to content of any of the entity's marketing plans.

In an alternative embodiment, the exposed/unexposed division may be made at finer levels of granularity. For example, if an entity has multiple marketing campaigns, each marketing campaign may have its own sets of exposed and unexposed confirmed users. This may be desirable, for example, to determine the relative effectiveness of the individual marketing campaigns At an even finer granularity, each item in a marketing plan (e.g. each distinct advertisement) may have its own set of exposed and unexposed confirmed users.

Media exposures 444 is merely one example of online behavior or “events” that MSTMS 102 may correlate with the confirmed visitor information.

An “event” may be an action or activity related to, associated with, performed or experienced by a user. In an embodiment, an indication of an event from originating source systems 100, such as user exposure or impression, triggers transmission of a message, data, flag, or signal to MSTMS 102. For example, a user visit to an online website or a user click on an advertisement that is part of a marketing campaign can prompt an event indicator from originating source systems 100 to MSTMS 102. In an embodiment, MSTMS 102 matches event indicators to users based on user identifying data and location data of corresponding user location records from data repository 172. In an embodiment, times at which user events occur are matched with corresponding event indicators for respective users. In an embodiment, for a specific user, user identifying data, for example a user device ID, is matched with corresponding location data identifying location of the user at any given time, tracking data identifying user movements, impression data identifying user exposures and time data of a respective user location record.

At the completion of phase 3, MSTMS 102 has divided the confirmed visitors into groups based on the events associated with the confirmed visitors. In one embodiment, phase 3 divides the confirmed visitors into at least two groups: exposed-confirmed-visitors and unexposed-confirmed-visitors. However, the number of groups may be significantly more than two. For example, each marketing campaign may have a distinct group of exposed-confirmed visitors. Based on the groupings, it is possible to determine, for example, the total number of visitors to Hawaii, and the total number of visitors to Hawaii that were exposed to a marketing campaign for Hawaii.

### Phase 4: Correlating Transaction Data

In phase 4, MSTMS 102 performs a correlation between the various groups of visitors to a particular entity and transactional data for those users. Transactional data may be data identifying purchases by a particular visitor before, during, or after a visit to an entity. Referring to FIG. 4D, it is a block diagram that illustrates the type of transaction data that may be correlated with the entity visitation data during phase 4. For example, the transaction data may include flight transaction data 464 (e.g. purchases of airline tickets), hotel transaction data 466 (e.g. purchases of hotel accommodations), any other transaction data (e.g. car reservations, attraction or rail tickets, restaurant purchases, etc.).

For example, of ten million people who came to California (determined during phase 2), one million may have been exposed to a marketing campaign (determined during phase 3), 500,000 of which made hotel accommodations at CA where they stayed for an average of 3.2 days and spent an average of $200 per day (determined in phase 4). This information can be used to enhance marketing plans and improve marketing revenues. Finer granularity statistics can help improve evaluation of the effectiveness of marketing goals. For example, the visitors to California may be grouped based on to which marketing campaign they had been exposed. The aggregated statistics for the visitors exposed to each campaign may show that those exposed to a first marketing campaign were more likely to go to California than those exposed to a second marketing campaign. Further, those per-campaign aggregate values may also show that those exposed to the first campaign stayed longer and spent more than those exposed to the second campaign.

### Correlating Data Sets

As described above, MSTMS 102 correlates various data sets obtained from various sources. MSTMS 102 may need to process a received data set or a data set file before storing the data set in data repository 172. MSTMS 102 may receive the native schema of a data set from an originating source. MSTMS 102 may use information about the native schema to process the data set according to the native schema.

In one embodiment, MSTMS 102 extracts and stores known data attributes and metadata attributes from data set(s) based on identifiers, originating source-related attributes, and/or comparison with the broader data available in data repository 172.

In an embodiment, a schema for a data set and/or for a set of identifiers may contain user identifying information uniquely identifying a user with which the records are associated. For example, in a travel-related data set, a traveler may be represented by his/her hashed email address using any number of encryption techniques, social media (or other channel) user GUID(s) (Global Unique IDentfier), internet address of traveler computer system(s), system identifiers of traveler computer systems, as well as organizational specific offline identifiers (e.g. loyalty identifier or user device identifier, and encrypted versions thereof).

During an example operation, criteria specified by a specific destination entity 110 may be applied to the records (saved in data repository 172) associated with the part of the data set that forms the basis of user identity(s) on which the criteria is requested. In a nonlimiting example, a criterion may be applied to user location records to identify user subsets that visited a particular entity, exposed to an event, or both. In an embodiment, user location records are tested against nested criteria. An example nested criterion may divide users into a group of users that were exposed to an event and a subgroup of the group of users that were exposed to the event for an exposed threshold of time.

In an embodiment, MSTMS 102 may receive data sets from originating source systems 100 dynamically, on a continuous basis, user location records are therefore routinely updated. The frequency by which user location records are updated may impact the accuracy of heuristics generated from the user location records because higher frequency rate updates provide larger data sets and larger data sets increase prediction accuracy.

In an embodiment, data processor 152 identifies a common user across the received data sets from originating source systems 104-1-104-N based on user identifying keys. In an embodiment, data processor 152 further determines destination entities that qualify as user home-locations, if any, and user away-location(s) by connecting users with user destinations. In an embodiment, data processor 152 performs aggregation of user information based on entity-specific geo-configuration data and generates a display of the aggregated information using GUI 158 for market visitation analysis.

### Aggregated Information Displays

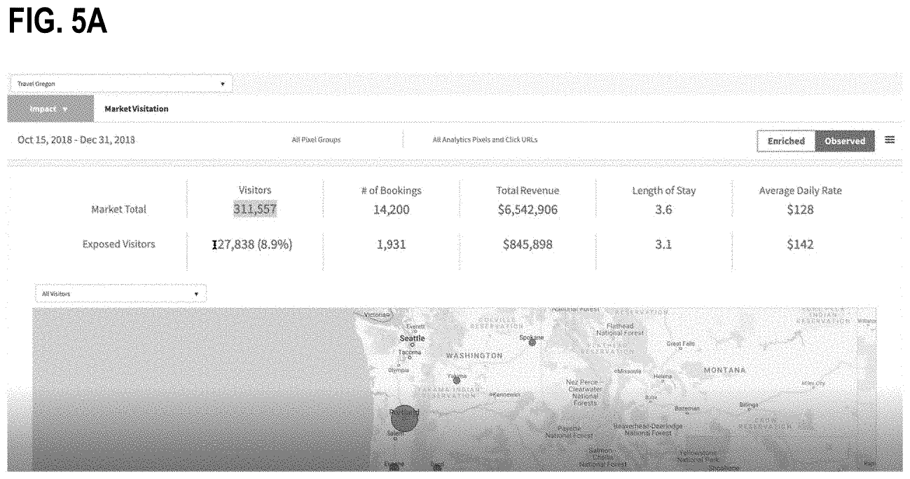

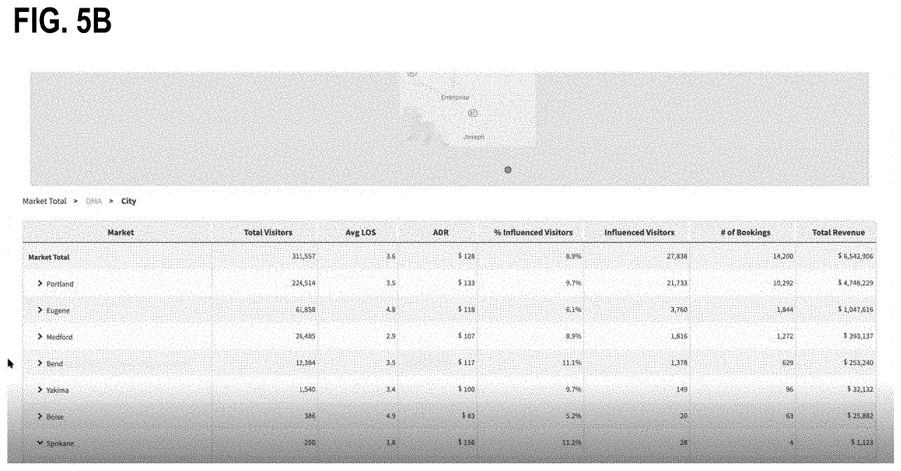

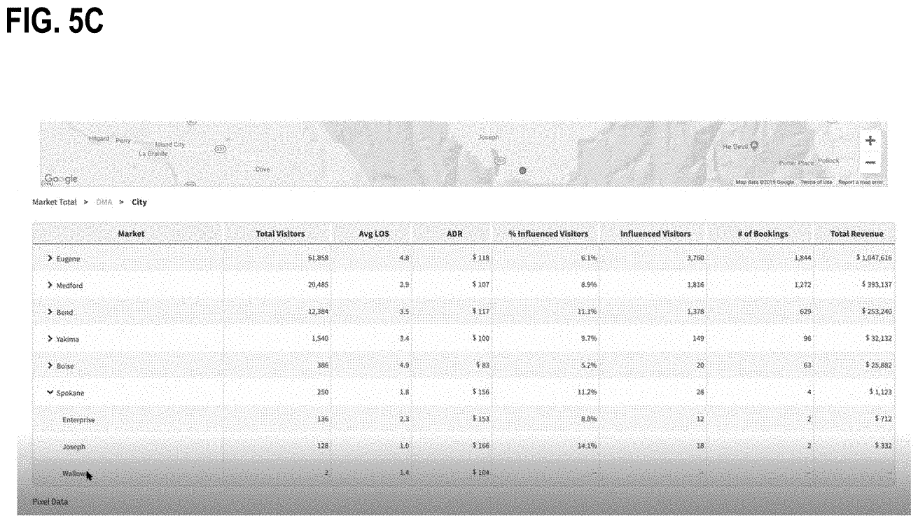

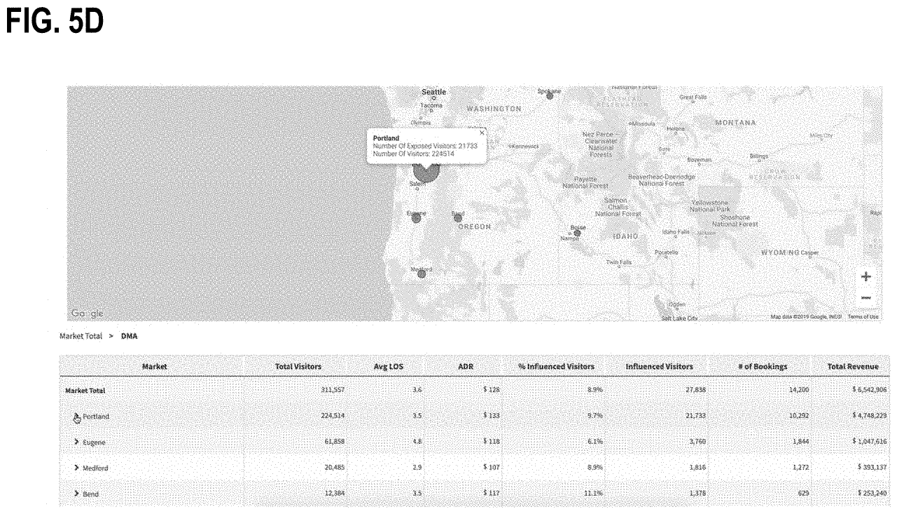

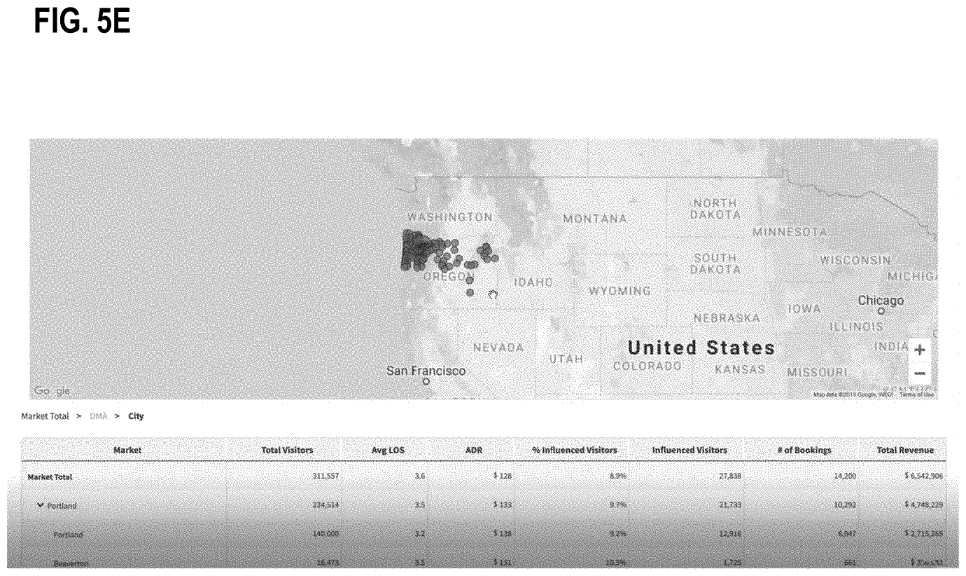

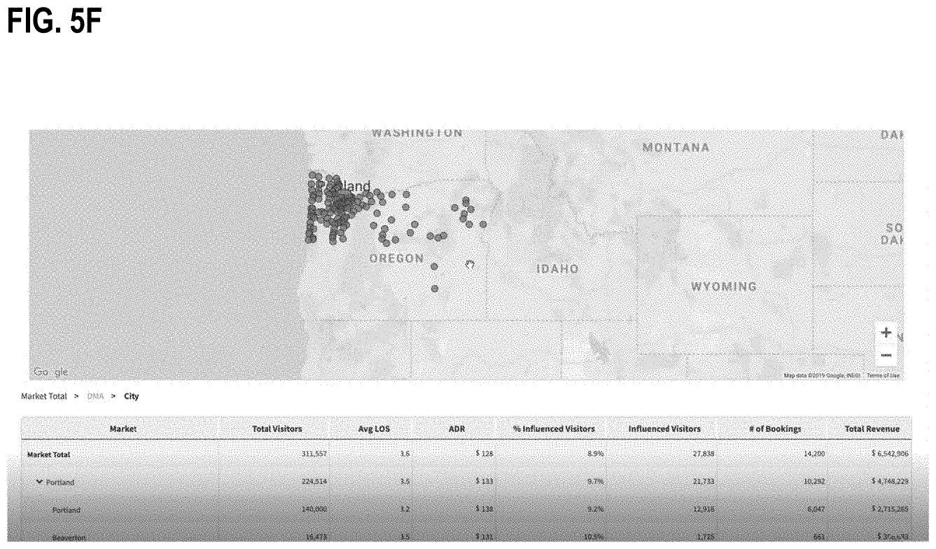

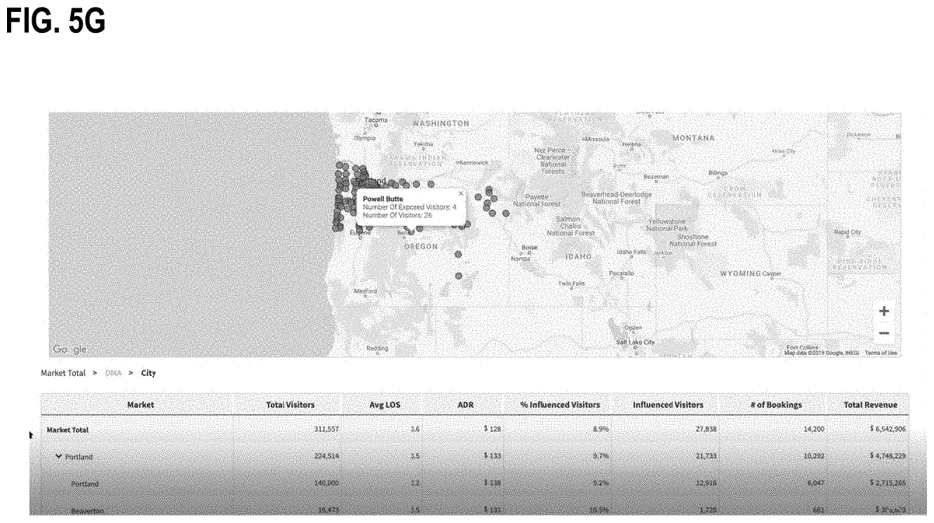

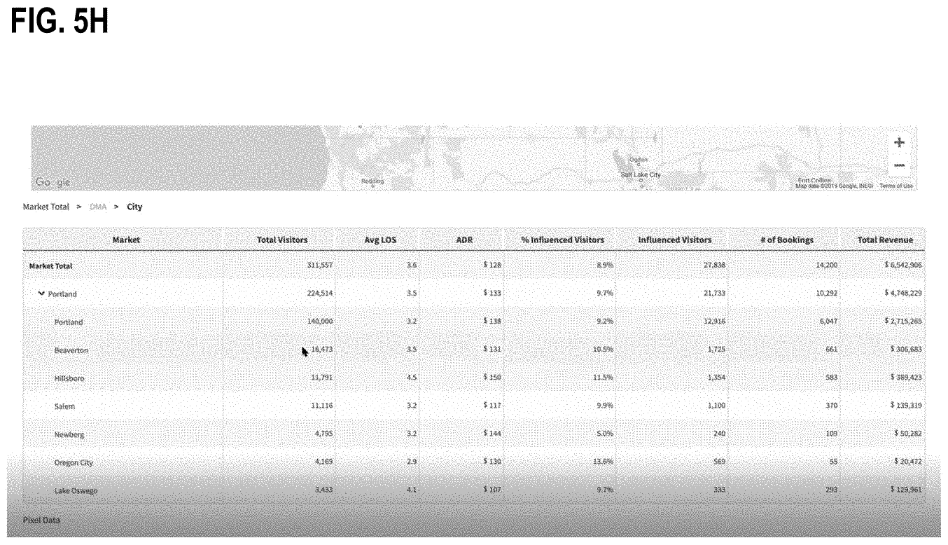

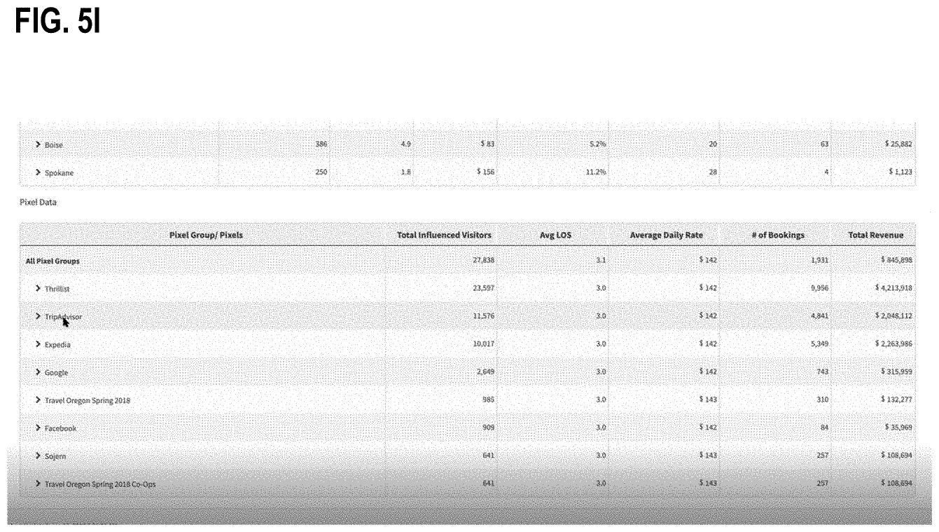

Once the visitors to an entity have been divided into distinct exposure groups, and those exposure groups have been correlated with transaction data, numerous useful user interface displays may be generated. FIGS. 5A-5I are example displays of aggregated information based on user behavior patterns produced by MSTMS 102. In an embodiment, MSTMS 102 is programmed to generate the displays illustrated in FIGS. 5A-5I.

In FIGS. 5A-5I, example displays of aggregated information are shown based on user behavior patterns, such as visitation patterns. The examples of FIGS. 5A-5I show market visitation statistics for a two-and-a-half-month time during, namely from Oct. 15, 2018 to Dec. 31, 2018. The granularity of the displayed data may be based on several factors including data update rate. Tracking a user location at hourly time intervals, for example, yields higher heuristics accuracy than tracking a user location at daily time intervals because, during a one-day period, an average user's movements are likely missed and not reflected in the statistics displays of the figures.

FIG. 5A shows an example display of aggregated information in the form of table data. From a total number of 311,557 online visitors to Oregon, a total of 14,200 visitors booked tickets to Oregon, generating total booked tickets revenue $6,542,906, with an average length of visitor stay of 3.6 days and an average visitor daily expenditure rate of $128. Of the 311,557-total number of online visitors, a total of 27,838 (or 8.9%) online visitors were exposed, and of those that were exposed, the total number of visitor bookings was 1,931 with a total bookings revenue of $845,898, an average length of visitor stay of 3.1 days, and an average visitor daily expenditure rate of $142. Interestingly, 8.9% of exposed visitors spent nearly 13% of the total revenues and with an approximately equal average number of days of stay and a higher daily expenditure rate possibly indicating that the exposure leads to increased revenues and justifies increased marketing campaign budget.

FIG. 5B shows an example display of aggregated market information in the form of table data. The table data includes a total number of visitors to specific regions in Oregon and neighboring states and related visitor behaviors. Specifically, a total of seven regions in Oregon and cross regions are listed: Portland, Eugene, Medlord, Bend, Yakima, Boise, and Spokane. In an example market data analysis, each of these regions is a designated marketing area (DMA) (i.e. a destination entity). For each entity, the total number of visitors during time duration, Oct. 15, 2018 to Dec. 21, 2018, average visitor length of stay (LOS), average visitor daily (expenditure) rate (ADR), percentage of influenced (or exposed) visitors, total number of influenced visitors, total number of visitor bookings, and the total visitor generated revenue are shown. Noteworthy, different DMA realize different visitor benefits. For example, from the 311,557—total number of online visitors, 224,514 visited the city of Portland, in Oregon, while less than half as many visitors, a total of 12,384 visitors, visited Bend. But the percentage of influenced visitors by marketing campaign(s) for Portland was 9.7% and 11.1% for Bend suggesting that the marketing campaign for Bend tends to benefit from greater impact, a relatively larger number of visitors to Bend were influenced relative to visitors to Portland. With the benefit of the foregoing market analysis, a change in current marketing plans to draw more visitors to Bend may be warranted. Market plan adjustments to increase the marketing campaign budget for Bend and extend the reach of the more effective Bend marketing campaign or directing part of the Portland marketing campaign resources to Bend may make better financial sense given the FIG. 5B market data.

FIG. 5C shows an example display of aggregated information in the form of table data. FIG. 5C display is similar to FIG. 5B display with finer granularity. Market data for Spokane is shown for three distinct regions, Enterprise, Joseph, and Wallow. FIG. 5D shows an example display of the aggregated market data of FIGS. 5B and 5C in combination with a map of the same regions. The map display shows some of the data for Portland with a click of the Portland region. A large red circle appears showing the total number of exposed visitors and the total number of visitors to Portland. FIG. 5E shows an example display of aggregated market information, in the form of table data, for various regions in a table display and a corresponding map display. Each of the circles on the map in and around Oregon corresponds to a region listed in the table. FIG. 5F shows an example display of aggregated market information in the form of table data with additional neighboring regions located inside and outside of Oregon on the map display. FIG. 5G shows a display of aggregated market information in the form of table data and map data for Powell Buffle where the number of visitors is a mere 26 out of which 4 are exposed to emphasize the benefit of comparison data for enhancing market plan. FIG. 5H shows an example display of aggregated market information of comparative data source campaign effects. Marketing campaign effects of online companies: Thrillist, TripAdvisor, Expedia, Google, Travel Oregon Sprint 2018, Facebook, Sojem, and Travel Oregon Spring 2018 Co-Ops are compared. For each site, FIG. 5H table data for the total number of visitors influenced by marketing campaign, average visitor stay, average daily expenditure rate, number of bookings, and total revenue, for each platform. The market analysis can lead to adjusting marketing resources dedicated to each site. Thrillist attracted the largest number of influenced visitors, approximately 27 thousand, who generated the largest amount of revenues, approximately $4 million. Comparatively, TripAdvisor did half as well as Thrillist while Sojern attracted a mere 641 influenced visitors who generated a total of approximately $100 thousand. An adjusted marketing plan can perhaps apply the amount of resources dedicated to Sojern to one of the top performers like TripAdvisor for greater campaign impact.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

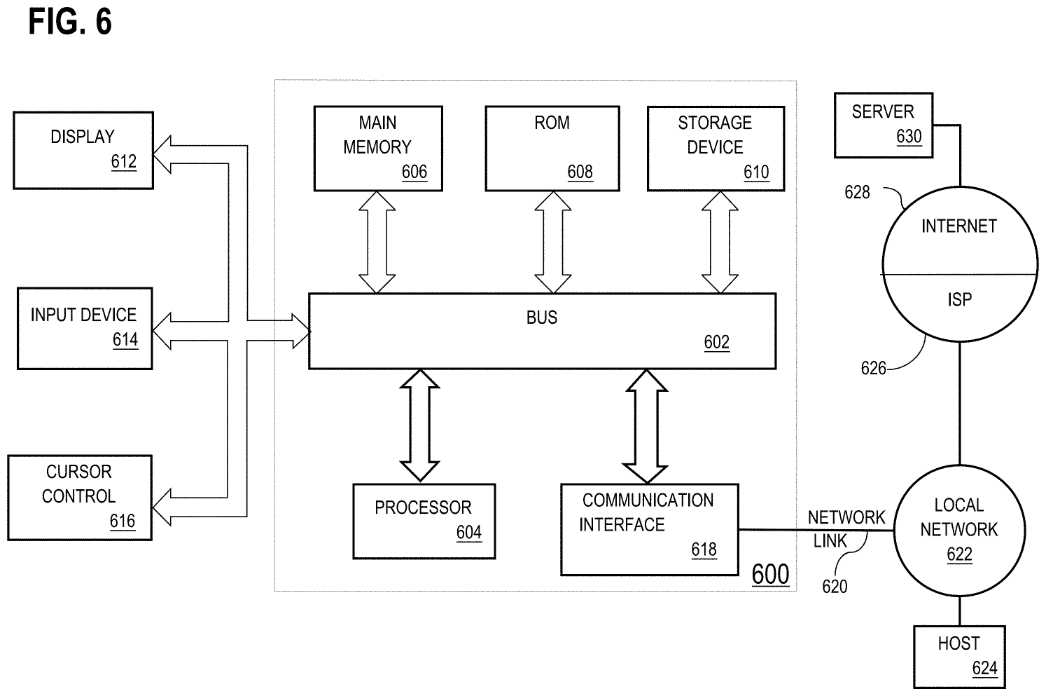

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 504. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 510. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal, and appropriate circuitry can place the data on bus 602. Bus 602 carries the data to main memory 606, from which processor 504 retrieves and executes the instructions. The instructions received by main memory 606 may optionally be stored on storage device 610 either before or after execution by processor 604.

Computer system 600 also includes a communication interface 618 coupled to bus 502. Communication interface 518 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626, in turn, provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 504 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Software System Overview

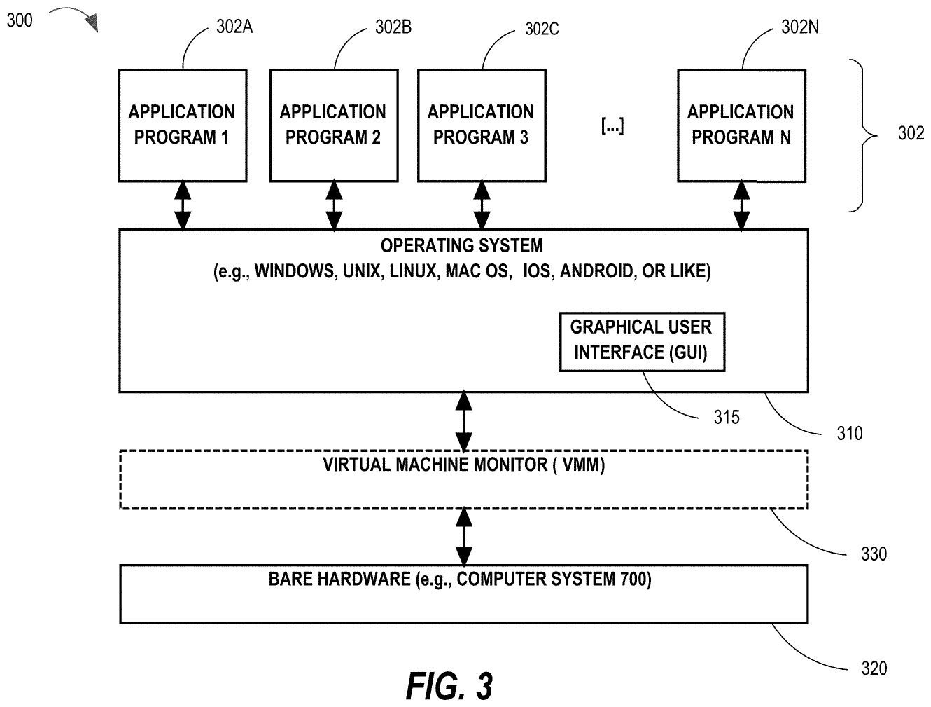

FIG. 3 is a block diagram of a basic software system 300 that may be employed for controlling the operation of computing system 600 of FIG. 6. Software system 300 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 300 is provided for directing the operation of computing system 600. Software system 300, which may be stored in system memory (RAM) 606 and on fixed storage (e.g., hard disk or flash memory) 610, includes a kernel or operating system (OS) 310.

The OS 310 manages low-level aspects of computer operation, including managing execution of processes, memory allocation, file input and output (I/O), and device I/O. One or more application programs, represented as 302A, 302B, 302C . . . 302N, may be “loaded” (e.g., transferred from fixed storage 610 into memory 606) for execution by the system 300. The applications or other software intended for use on computer system 600 may also be stored as a set of downloadable computer-executable instructions, for example, for downloading and installation from an Internet location (e.g., a Web server, an app store, or another online service).

Software system 300 includes a graphical user interface (GUI) 315, for receiving user commands and data in a graphical (e.g., “point-and-click” or “touch gesture”) fashion. These inputs, in turn, may be acted upon by the system 300 in accordance with instructions from operating system 310 and/or application(s) 302. The GUI 315 also serves to display the results of operation from the OS 310 and application(s) 302, whereupon the user may supply additional inputs or terminate the session (e.g., log off).

OS 310 can execute directly on the bare hardware 320 (e.g., processor(s) 604) of computer system 600. Alternatively, a hypervisor or virtual machine monitor (VMM) 330 may be interposed between the bare hardware 620 and the OS 310. In this configuration, VMM 330 acts as a software “cushion” or virtualization layer between the OS 310 and the bare hardware 320 of the computer system 600.

VMM 330 instantiates and runs one or more virtual machine instances (“guest machines”). Each guest machine comprises a “guest” operating system, such as OS 310, and one or more applications, such as application(s) 302, designed to execute on the guest operating system. The VMM 330 presents the guest operating systems with a virtual operating platform and manages the execution of the guest operating systems.

In some instances, the VMM 330 may allow a guest operating system to run as if it is running on the bare hardware 320 of computer system 600 directly. In these instances, the same version of the guest operating system configured to execute on the bare hardware 320 directly may also execute on VMM 330 without modification or reconfiguration. In other words, VMM 330 may provide full hardware and CPU virtualization to a guest operating system in some instances.

In other instances, a guest operating system may be specially designed or configured to execute on VMM 330 for efficiency. In these instances, the guest operating system is “aware” that it executes on a virtual machine monitor. In other words, VMM 330 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system and may run under the control of other programs being executed on the computer system.

Multiple threads may run within a process. Each thread also comprises an allotment of hardware processing time but share access to the memory allotted to the process. The memory is used to store the content of processors between the allotments when the thread is not running. The term thread may also be used to refer to a computer system process in multiple threads are not running.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers. In a cloud computing environment, there is no insight into the application or the application data. For a disconnection-requiring planned operation, with techniques discussed herein, it is possible to release and then to later rebalance sessions with no disruption to applications.

The above-described basic computer hardware and software and cloud computing environment presented for the purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

What is claimed is:

1. A computer-implemented method for determining visited entities on a per-user basis, comprising:
receiving, over one or more network systems, user-location data from a plurality of distinct sources;
generating, from the user-location data, a plurality of user-location records;
wherein the user-location records indicate visits made by the plurality of users to a plurality of locations;
wherein each user-location record includes at least:
user-identification data that uniquely identifies a user;
location data that identifies a location visited by the user identified in the user-location record;
time data that indicates when the user identified in the user-location record visited the location identified in the user-location record;
based on the plurality of user-location records, determining for each user of the plurality of users, whether any location visited by the user qualifies as a home-location for the user;
wherein locations visited by each user that do not qualify as the home-location for the user are away-locations for the user;
receiving, entity-specific geo-configuration data that indicates, for each entity of a plurality of entities, one or more geographic locations associated with the entity; and
for the away-locations of each user of the plurality of users, determining one or more entities visited by the user based on the entity-specific geo-configuration data and the away-locations visited by the user.

2. The method of claim 1 further comprising determining impact of exposure to particular content by:
for a particular entity of the plurality of entities, determining a subset of users, of the plurality of users, that visited the entity and were exposed to the particular content; and
generating a display that includes aggregate information based on information collected about the subset of users.

3. The method of claim 2 wherein:
the subset of users is a first subset of users;
the aggregate information is first aggregate information; and
the method includes identifying a second subset of users, from the plurality of users, that:
visited the particular entity; and
were not exposed to the particular content;
the method further comprises displaying, separate from the first aggregate information, second aggregate information based on information collected about the second subset of users.

4. The method of claim 2, wherein determining for each user of the plurality of users whether any location visited by the user qualifies as a home-location for the user further comprises:
the subset of users is a first subset of users;
the aggregate information is first aggregate information; and
the method includes identifying a second subset of users, from the plurality of users, that:
visited the particular entity during time window; and
were exposed to the particular content for at least an exposed threshold of time;
the display also includes, separate from the first and second aggregate information, third aggregate information based on information collected about a third subset of users.

5. The method of claim 2, wherein determining for each user of the plurality of users whether any location visited by the user qualifies as a home-location for the user further comprises:
the subset of users is a first subset of users;
the aggregate information is first aggregate information; and
the method includes identifying a second subset of users, from the plurality of users, that:
visited the particular entity during a time window; and
were exposed to the particular content;
the display also includes, separate from the first aggregate information, second aggregate information based on information collected about the second subset of users.

6. The method of claim 5, wherein determining for each user of the plurality of users that visited the entity and were exposed to particular content further comprises:
the method includes identifying a third subset of users, from the plurality of users, that:
based on a threshold, were exposed to the particular content;
the display also includes, separate from the first aggregate information, the second aggregate information, third aggregate information based on information collected about the third subset of users.

7. The method of claim 6, wherein:
the user-location records include transactional data;
the method further identifying a fourth subset of users, from the plurality of users, that:
visited the particular entity based on an average time duration all users of each of the first, second, and third subsets of users visited the particular entity and an average daily expenditure for accommodations by all users of each of the first, second, and third subsets of users at the particular entity;
the display also includes, separate from the first aggregate information, the second aggregate information, and the third aggregate information, fourth aggregate information based on information collected about the fourth subset of users.

8. The method of claim 5, further comprises:
for each user of the second subset of users that visited the particular entity, identifying a fourth subset of users, from the second subset of users, a total number of times each user of the fourth subset of users was not exposed to the particular content;
the display also includes, separate from the first and the second aggregate information, fourth aggregate information, if any, based on information collected about the fourth subset of users.

9. A computer-implemented method comprising:
from one or more distinct sources associated with one or more entities, receiving, over one or more network systems, user-location data from one or more of the one or more distinct sources;
wherein the user-location data includes a plurality of user-location records;
wherein the user-location records indicate visits made by the plurality of users to a plurality of locations;
wherein each user-location record includes at least:
user-identification data that uniquely identifies a user;
location data that identifies a location visited by the user identified in the user-location record;
time information that indicates when the user identified in the user-location record visited the location identified in the user-location record;
based on the plurality of user-location records, determining for each user of the plurality of users whether any location visited by the user qualifies as a home-location for the user;
wherein locations visited by each user that do not qualify as the home-location for the user are away-locations for the user;
receiving, entity-specific geo-configuration data that indicates, for each entity of a plurality of entities, one or more geographic locations associated with the entity;
for the away-locations of each user of the plurality of users, determining one or more entities visited by the user based on the entity-specific geo-configuration data and the user-location records;
for a particular entity of the plurality of entities, determining a subset of users, of the plurality of users, that visited the entity and were exposed to particular content; and
generating a display that includes aggregate information based on information collected about the subset of users.

10. The method of claim 9, wherein:
determining for each user of the plurality of users, whether any location visited by the user qualifies as a home-location for the user further comprises:
for at least one user, determining no location visited by the user qualifies as a home-location for the user.

11. The method of claim 9,
wherein user-identification data of at least one user of the plurality of users includes an electronic address data uniquely identifying an electronic address associated with at least one user of the plurality of users, an entity account data uniquely identifying a user account associated with the at least one of the plurality of users, a cookie identification data uniquely identifying tracking of at least one of the one or more entities visited by the at least one user of the plurality of users, a device identification data uniquely identifying an electronic device associated with the at least one user of the plurality of users, or a combination thereof.

12. The method of claim 9,
wherein receiving the user-location data from one or more of the one or more distinct sources is performed dynamically, at regular time intervals;
the method further includes updating the user-location data at the regular time intervals.

13. The method of claim 9, wherein at least a part of the user-identification data is impression data indicative of an action or activity performed by a corresponding user of the plurality of users when viewing the particular content.

14. The method of claim 9,
wherein the subset of users is a first subset of users;
the aggregate information is first aggregate information; and
the method includes, using user-identification data, identifying a second subset of users, from the plurality of users, that:
visited the particular entity; and
were not exposed to the particular content;
the display also includes, separate from the first aggregate information, second aggregate information based on information collected about the second subset of users.

15. The method of claim 9,
the subset of users is a first subset of users;
the aggregate information is first aggregate information; and
the method includes identifying a second subset of users, from the plurality of users, that:
visited the particular entity during time window; and
were exposed to the particular content for at least an exposed threshold of time;
the display also includes, separate from the first aggregate information, second aggregate information based on information collected about the second subset of users.

16. The method of claim 9, wherein determining for each user of the plurality of users whether any location visited by the user qualifies as a home-location for the user further comprises:
the subset of users is a first subset of users;
the aggregate information is first aggregate information; and
the method includes identifying a second subset of users, from the plurality of users, that:
visited the particular entity during a time window; and
were exposed to the particular content;
the display also includes, separate from the first aggregate information, second aggregate information based on information collected about the second subset of users.

17. A computing system comprising one or more processors and memory, the memory storing instruction which, when executed on the one or more processors, cause:
receiving, over one or more network systems, user-location data from a plurality of distinct sources;
wherein the user-location data includes a plurality of user-location records;
wherein the user-location records indicate visits made by the plurality of users to a plurality of locations;
wherein each user-location record includes at least:
user-identification data that uniquely identifies a user;
location data that identifies a location visited by the user identified in the user-location record;
time information that indicates when the user identified in the user-location record visited the location identified in the user-location record;
based on the plurality of user-location records, determining for each user of the plurality of users whether any location visited by the user qualifies as a home-location for the user;
wherein locations visited by each user that do not qualify as the home-location for the user are away-locations for the user;
receiving, entity-specific geo-configuration data that indicates, for each entity of a plurality of entities, one or more geographic locations associated with the entity;
for the away-locations of each user of the plurality of users, determining one or more entities visited by the user based on the entity-specific geo-configuration data and the user-location records;
for a particular entity of the plurality of entities, determining a subset of users, of the plurality of users, that visited the entity and were exposed to particular content; and
generating a display that includes aggregate information based on information collected about the subset of users.

18. The computing system of claim 14, wherein the instructions include instruction which, when executed by the one or more processors, further cause:
the subset of users is a first subset of users;
the aggregate information is first aggregate information; and
the method includes identifying a second subset of users, from the plurality of users, that:
visited the particular entity; and
were not exposed to the particular content;
the display also includes, separate from the first aggregate information, second aggregate information based on information collected about the second subset of users.

19. The computing system of claim 17, wherein the instructions include instruction which, when executed by the one or more processors, further cause:
the subset of users is a first subset of users;
the aggregate information is first aggregate information; and
the method includes identifying a second subset of users, from the plurality of users, that:
visited the particular entity; and
were not exposed to the particular content;
the display also includes, separate from the first aggregate information, second aggregate information based on information collected about the second subset of users.

20. The computing system of claim 14, wherein the instructions include instruction which, when executed by the one or more processors, further cause:
the subset of users is a first subset of users;
the aggregate information is first aggregate information; and
the method includes identifying a second subset of users, from the plurality of users, that:
visited the particular entity during a time window; and
were exposed to the particular content;
the display also includes, separate from the first aggregate information, second aggregate information based on information collected about the second subset of users.

21. The method of claim 20, wherein the instructions include instruction which, when executed by the one or more processors, further cause:
identifying a third subset of users from the plurality of users, that:
were exposed to the particular content based on a threshold;
the display also includes, separate from the first aggregate information and the second aggregate information, third aggregate information based on information collected about the third subset of users.
